(19) United States
(12) Patent Application Publication
(10) Pub. No.: US 2003/0208020 A1
(43) Pub. Date: Nov. 6, 2003

(54) Water absorbing polymer

(76) Inventors: Thomas Daniel, Waldsee (DE); Ulrich Riegel, Frankfurt (DE); Shin-Ichiro Nakamura, Kanagawa (JP); Yasumi Shimizu, Osaka (JP); Tohru Matsutomi, Osaka (JP)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/140,279

(22) Filed: May 6, 2002

(51) Int. Cl. C08F 120/06

(52) U.S. Cl. 526/317.1; 526/303.1; 524/556; 525/330.2; 525/387; 525/329.5; 525/329.6; 525/243

(57) ABSTRACT

Highly water absorbing polymer comprising a polymerizable compound having carbon-carbon double bonds or a salt thereof, obtainable by using a crosslinking agent comprising a hydroxy polyallyl ether having one or more hydroxy groups and two or more allyl groups.

The invention concerns a highly water absorbing polymer comprising a polymerizable compound having carbon-carbon double bonds or a salt thereof, obtainable by using a crosslinking agent comprising a hydroxy polyallyl ether having one or more hydroxy groups and two or more allyl groups.

Most of highly water absorptive polymers made of polymerizable compounds having a polymerizable double bond (for example, carbon-carbon double bond) or salts thereof comprise acrylate polymers as the main ingredient and they are produced mainly by an aqueous solution polymerization process. As the crosslinking agent for crosslinking highly water absorbing polymer, there has been proposed use of various substances such as acrylic acid esters, acrylic acid amides and allyl ethers having a reactive double bond. Among them, it has been reported that a polymer of excellent water absorbing performance can be obtained by using an allyl type compound as the crosslinking agent. Further, a reversed phase suspension polymerization method of conducting polymerization by dissolving a monomer and a crosslinking agent in water suspended into an organic solvent has also been practiced industrially and the reversed phase suspension polymerization method can also be regarded as polymerization in an aqueous medium.

For example, it has been reported in J. Polym. Sci. A A: Polym. Chem., 35, 799 (1997) that a polymer more excellent in water absorbing performance can be obtained when polyethylene glycol diallyl ether is used as the crosslinking agent compared with the case of using the acrylic crosslinking agent. However, the performance as the crosslinking agent is not sufficient. A method of neutralizing a polymer obtained by polymerization of acrylic acid has been know. Japanese Patent Laid-Open No. 174414/1991 using this method discloses a use of tetra allyloxy ethane as a concrete allyl compound. However, the compound has drawbacks such as insufficient heat resistance, insufficient solubility to an aqueous monomer solution and insufficient resistance to hydrolysis and it has been demanded for the development of a crosslinking agent of higher performance. Further, Japanese Patent Laid-Open No. 246403/1992 disclosed use of triallyl amine, triallyl cyanurate, triallyl isocyanurate and triallyl phosphate. However, all of the crosslinking agents have drawbacks such as insufficient heat resistance, undesired effects on polymerizing reaction, insufficient solubility to an aqueous monomer solution and insufficient resistance to hydrolysis and any of them is not practical.

Generally, for the aqueous solution polymerization method, it has been adopted a method of neutralizing an aqueous solution of acrylic monomer by about 75%, for example, with an aqueous solution of sodium hydroxide, mixing a crosslinking agent, polymerizing the same by a polymerization initiator and cutting a resultant solid to an appropriate size and drying the same (hereinafter referred to as “after neutralization polymerization method”). Further, when a crosslinking agent is less soluble to an aqueous solution after neutralization, a method of dissolving the crosslinking agent in an aqueous solution of acrylic acid, polymerizing the same and neutralizing a resultant solid while cutting has been adopted (hereinafter referred to as before neutralization polymerization method) but this method is disadvantageous in view of the production efficiency and the uniformness for the degree of neutralization in the product compared with the case of neutralization in the state of solution.

It is an object of this invention to provide a novel highly water absorbing polymer having a water absorbing performance required at an practical level, obtainable by using an allyl type crosslinking agent for the production which has solubility to an aqueous solution of a monomer (for example, an aqueous solution of acrylic acid salt) and free from drawbacks as in the prior art.

The present inventors have found that a hydroxy polyallyl ether having two or more allyl ether groups is industrially useful for the after neutralization polymerization method as well as before neutralization polymerization method described above as an allyl compound capable of attaining the foregoing subject and have accomplished this invention.

This invention provides a crosslinking agent comprising a hydroxy polyallyl ether having one or more hydroxy groups and two or more allyl groups to be used for the production of highly water absorbing polymer comprising a polymerizable compound having a carbon-carbon double bond or a salt hereof.

In this invention, the hydroxy polyallyl ether is used as a crosslinking agent for the production of a highly water absorbing polymer. The crosslinking agent comprises a hydroxy polyallyl ether or comprises a mixture of two or more kinds of hydroxy polyallyl ethers. The molecule of the hydroxy polyallyl ether has one or more hydroxyl groups and two or more allyl groups. The number of the hydroxyl groups is 1 or more, for example, 2 or more and the example for the number of the hydroxyl groups is 1 to 10, particularly, 1 to 4. The number of the allyl groups is 2 or more, for example, 3 or more and 3 to 8 as an example. In a case of the mixture of the hydroxy polyallyl ethers, the average number of the hydroxyl groups is 0.5 or more, for example, 1.0 or more, particularly, 1.5 or more and the average number of the allyl group is 2.0 or more, for example, 2.5 or more and, particularly, 3.0 or more. The number of the hydroxyl groups and the allyl groups (also including the average number) is measured by NMR (particularly ¹HNMR).

The hydroxy polyallyl ether is generally obtained by allyl etherifying two or more of the hydroxyl groups of a polyol compound. The allyl etherification can be conducted by using an allyl etherifying agent. In the allyl etherification of the polyol compound, the hydrogen atom of the hydroxyl group is substituted by the allyl group.

The polyol compound has three or more, for example, four or more hydroxyl groups. The polyol compound is preferably a compound represented by the formula:

R(OH)ₙ

where R represents a hydrocarbon group of 4 to 12 carbon atoms having a linear, branched or cyclic structure which may contain an ether linkage oxygen atom and n is an integer of 3 to 10 (for example, 4 to 8)).

Concrete examples of the polyol compound is a linear compound of 4 to 10 carbon atoms (for example, erythritol, xylitol and sorbitol), a branched compound of 4 to 12 carbon atoms (for example, pentaerythritol and dipentaerythritol) or a cyclic compound of 4 to 12 carbon atoms (for example, glucose, fructose, maltose, sucrose and lactose).

The allyl etherifying agent is a compound having an allyl group and a reactive group. The allyl group and the reactive group may be bonded by a direct bond but may be bonded by way of a bivalent organic group (for example, substituted or not substituted hydrocarbon group (for example, of 1 to 12 carbon atoms)). Usually, the allyl etherifying agent has one allyl group and one reactive group bonded by direct bonding. Examples of the reactive group in the allyl etherifying agent include, for example, halogen atom, alkyl sulfonyl oxy group (with the number of carbon atoms in the alkyl group, for example, of 1 to 10), aryl sulfonyl oxy group (with the number of carbon atoms in the aryl group, for example, of 6 to 20), and aralkyl sulfonyl oxy group (with the number of carbon atoms in the aralkyl group, for example, of 7 to 30).

Examples of the halogen atom include chlorine and bromine. Examples of the alkyl sulfonyloxy group include a methyl sulfonyloxy group, an ethyl sulfonyloxy group, a n-propyl sulfonyloxy group, an isopropyl sulfonyloxy group, a n-butyl sulfonyloxy group, a n-octyl sulfonyloxy group, a trifluormethane sulfonyloxy group, a trichloromethane sulfonyloxy group, a 2-chloro-1-ethane sulfonyloxy group, a 2,2,2-trifluoroethane sulfonyloxy group, a 3-chloropropane sulfonyloxy group, and a perfluoro-1-butane sulfonyloxy group.

Examples of the aryl sulfonyloxy group include a benzene sulfonyloxy group, a 2-aminobenzene sulfonyloxy group, a 2-nitrobenzene sulfonyloxy group, a 2-methoxycarbonyl benzene sulfonyloxy group, a 3-aminobenzene sulfonyloxy group, a 3-nitrobenzene sulfonyloxy group, a 3-methoxycarbonyl benzene sulfonyloxy group, a p-toluene sulfonyloxy group, a 4-tert-butylbenzene sulfonyloxy group, a 4-fluorobenzene sulfonyloxy group, a 4-chlorobenzene sulfonyloxy group, a 4-bromobenzene sulfonyloxy group, a 4-iodobenzene sulfonyloxy group, a 4-methoxybenzene sulfonyloxy group, a 4-aminobenzene sulfonyloxy group, a 4-nitrobenzene sulfonyloxy group, a 2,5-dichlorobenzene sulfonyloxy group, a pentafluorobenzene sulfonyloxy group, a 1-naphthalene sulfonyloxy group, and a 2-naphthalene sulfonyloxy group.

Examples of the aralkyl sulfonyloxy group include an α-toluene sulfonyloxy group, a trans-β-styrene sulfonyloxy group, and a 2-nitro-α-toluene sulfonyloxy group.

Examples of the allyletherifying agent include an allyl halide, an alkyl sulfonyloxyally, an aryl sulfonyloxyallyl, and an aralkyl sulfonyloxyallyl.

Examples of the allyl halide include allyl chloride and allyl bromide.

Examples of the alkyl sulfonyloxyallyl include methyl sulfonyloxyallyl, ethyl sulfonyloxyallyl, n-propyl sulfonyloxyallyl, isopropyl sulfonyloxyallyl, n-butyl sulfonyloxyallyl, n-octyl sulfonyloxyallyl, trifluoromethane sulfonyloxyallyl, trichloromethane sulfonyloxyallyl, 2-chloro-1-ethane sulfonyloxyallyl, trichloromethane sulfonyloxyallyl, 2-chloro-1-ethane sulfonyloxyallyl, 2,2,2-trifluoroethane sulfonyloxyallyl, 3-chloropropane sulfonyloxyallyl, and perfluoro-1-butane sulfonyloxyallyl.

Examples of the aryl sulfonyloxyallyl include benzene sulfonyloxyallyl, 2-aminobenzene sulfonyloxyallyl, 2-nitrobenzene sulfonyloxyallyl, 2-methoxycarbonyl benzene sulfonyloxyallyl, 3-aminobenzene sulfonyloxyallyl, 3-nitrobenzene sulfonyloxyallyl, 3-methoxycarbonylbenzene sulfonyloxyallyl, p-toluene sulfonyloxyallyl, 4-tert-butyl benzene sulfonyloxyallyl, 4-fluorobenzene sulfonyloxyallyl, 4-chlorobenzene sulfonyloxyallyl, 4-bromobenzene sulfonyloxyallyl, 4-iodobenzene sulfonyloxyallyl, 4-bromobenzene sulfonyloxyallyl, 4-iodobenzene sulfonyloxyallyl, 4-methoxybenzene sulfonyloxyallyl, 4-aminobenzene sulfonyloxyallyl, 4-nitrobenzene sulfonyloxyallyl, 2,5-dichlorobenzene sulfonyloxyallyl, pentafluorobenzene sulfonyloxyallyl, 1-naphthalene sulfonyloxyallyl, and 2-naphthalene sulfonyloxyallyl.

Examples of the aralkyl sulfonyloxyallyl include α-toluene sulfonyloxyallyl, trans-β-styrene sulfonyloxyallyl and 2-nitro-α-toluene sulfonyloxyallyl.

The hydroxy polyallyl ether is preferably represented by:

R(OH)ₓ(OA)_{y}

(where R has the same meaning as described above, x represents an integer of 1 or more and y represents an integer of 2 or more providing that x+y=n (n as has been defined for the polyol compound, and 10 or less) and A represents an allyl group).

For obtaining a hydroxy polyallyl ether by allyl etherifying a polyol compound, the following method has been adopted generally. To an appropriate reactor equipped with a stirrer, a thermometer and a reflux condenser, are charged 1 mol part of a polyol compound, y mol part of potassium hydroxide or sodium hydroxide and 10 to 50% by weight of water or aprotic polar solvent (for example, acetonitrile, tetrahydrofuran, dioxane or dimethyl formamide), heated under stirring to about 50 to 150° C., to which y mol part of allyl etherifying agent is dropped and reacted for about 2 to 10 hours. After the completion of the reaction, a resultant liquid layer is separated from a precipitated solid and can be purified by a customary method such as distillation, extraction, recrystallization and liquid chromatography. Sodium hydroxide or potassium hydroxide may be dropped as an aqueous solution together with the allyl etherifying agent into the reaction system.

In a preferred first embodiment of this invention, the hydroxy polyallyl ether is a compound obtained from a linear polyol compound of 4 to 10 carbon atoms by allyl etherifying three or more of the hydroxy groups thereof. The hydroxy polyallyl ether described above can include, for example, erythritol triallyl ether, xylitol triallyl ether, xylitol tetraallyl ether, sorbitol triallyl ether, sorbitol tetraallyl ether and sorbitol pentaallyl ether.

In a preferred second embodiment of this invention, the hydroxy polyallyl ether is a compound obtained from a branched polyol compound of 4 to 12 carbon atoms by allyl etherifying three or more of the hydroxy groups thereof. The hydroxy polyallyl ether described above can include, for example, dipentaerytyritol triallyl ether, dipentaerytyritol tetraallyl ether, and dipentaerytyritol pentaallyl ether.

In a preferred third embodiment of this invention, the hydroxy polyallyl ether is a compound obtained from a cyclic polyol compound of 4 to 12 carbon atoms by allyl etherifying three or more of the hydroxy groups thereof. The hydroxy polyallyl ether described above can include, for example, glucose triallyl ether, glucose tetraallyl ether, fructose triallyl ether, fructose tetraallyl ether, maltose triallyl ether, maltose tetraallyl ether, maltose pentaallyl ether, maltose hexaallyl ether, maltose heptaallyl ether, sucrose triallyl ether, sucrose tetraallyl ether, sucrose pentaallyl ether, sucrose hexaallyl ether, sucrose heptaallyl ether, lactose triallyl ether, lactose tetraallyl ether, lactose pentaallyl ether, lactose hexaallyl ether and lactose heptaallyl ether.

In this invention, a hydroxy polyallyl ether having two allyl groups may also be used. Examples of such hydroxy polyallyl ether can include, for example, erythritol diallyl ether, pentaerythritol diallyl ether and glucose diallyl ether.

The crosslinking agent of this invention is used in the production of a highly absorbing polymer for crosslinking the polymer. Generally, the crosslinking agent of this invention crosslinks a highly water absorbing polymer in an aqueous medium. The crosslinking reaction and the polymerizing reaction may be conducted simultaneously or the crosslinking reaction may be conducted after the polymerizing reaction. Generally, the crosslinking agent of this invention is used in the production of a highly water absorbing polymer which is polymerized in the aqueous medium and comprising a polymerizable compound having a carbon-carbon double bond or a salt thereof. In the production of the highly water absorbing polymer, the polymerizable compound and/or the salt thereof is used as a monomer.

The repeating unit in the highly water absorbing polymer has a functional group. Examples of the functional group can include, carboxyl group, hydroxyl group, amide group and acetoamide group. Examples of the highly water absorbing polymer includes an acrylic acid type polymer, vinyl alcoholic polymer, isobutylene/maleic anhydride type polymer, acrylamide type polymer, acrylamide/acrylic acid type polymer and N-vinyl acetamide type polymer, Generally, a monomer forming a highly water absorbing polymer has a functional group. However, as in a case of polyvinyl alcohol, monomer may be a vinyl ester, for example, vinyl acetate or vinyl propanoate and a functional group such as a hydroxy group may be induced after the synthesis of the polymer.

Examples of the monomer that form the highly water absorbing polymer can include acrylic acid, methacrylic acid, maleic acid, fumaric acid, itaconic arid, crotonic acid, citraconic acid, α-hydroxyacrylic acid, aconitic acid, 2(meth)acryloyl ethane sulfonic acid, 2-(meth)acrylamido-2-methyl propane sulfonic acid and a salt thereof. The salt can include metal salts. Example of metals in the salt are alkali metals (for example, potassium or sodium).

The mixture of a monomer and an aqueous medium is preferably a mixture capable of dissolving a crosslinking agent. The solubility of the crosslinking agent may be 0.2 g or more, for example, 0.4 g or more, particularly, 1 g or more and, especially, 5 g or more based on 100 ml of the mixture of the monomer and the aqueous medium. The aqueous medium consists only of water or comprises water and a water soluble organic solvent (for example, alcohol). The highly water absorbing polymer may generally comprise a complete or partial, salt of a carboxylic acid as a main ingredient.

The crosslinking agent of this invention is used by a known method with no particular restriction. For example, a highly water absorbing polymer can be produced, by neutralizing an aqueous solution of an acrylic acid monomer by 60 to 90 mol% which an aqueous solution of sodium hydroxide to form an aqueous solution of 30 to 50% by weight, mixing a crosslinking agent by 0.1 to 1.0% by weight and polymerizing the same with addition of a radical polymerization initiator of a redox type such as an azo type or peroxide type usually at a temperature of about 100° C. or lower, cutting a resultant polymer into pieces of suitable size and drying them (after neutralization polymerization method).

Alternatively, it may be produced by polymerizing an aqueous solution of a not neutralized acrylic monomer with addition of a polymerization initiator, cutting a resultant solid into pieces of sutable size and then subjecting the same to a neutralizing treatment with sodium hydroxide (before neutralization polymerization method). The crosslinking agent of this invention consists only of the hydroxy polyallyl ether or comprises a liquid mixture, for example, an aqueous solution of a hydroxy polyallyl ether.

### EXAMPLE

This invention is to be explained specifically with reference to examples and comparative examples. The water absorbing performance of the powdery polymer (water absorption amount (g) per 1 g of powdery polymer) was evaluated as described below. About 0.2 g of a powdery polymer was weighted accurately, placed uniformly in a tea bag made of non-woven fabric (6.8 mm×9.6 mm), and dipped in 0.9% saline, and the weight one hour after is measured. The water absorbing performance of the powdery polymer was calculated in accordance with the following equation with the water absorption weight only for the tea bag as a blank.

Water absorbing performance-(weight after absorption (g)-blank (g))/(Weight of high water absorbing polymer (g))

CRC and SFC are well established methods to characterize water absorbent polymers.

AUL 0.01, AUL 0.29, AUL 0.57, AUL 0.90, PAI, Extractables are measured as described in EP 962 206 which is included by reference.

(1) Preparation of Crosslinking Agent

### Example 1

To a 2 liter four necked flask to which a stirrer, a dropping funnel, a reflux condenser, a thermometer and a mechanical stirrer were set, 455 g (2.5 mol) of D-sorbitol, 421 g (7.5 mol) of potassium hydroxide and 150 mL of water were charged and stirred under heating by a mantle heater to form a slightly turbid pale yellow solution at 135° C. When dropping of allyl bromide thereto was started, reflux was initiated and the liquid temperature was lowered to about 95° C. Subsequently, moderate refraction continued at a liquid temperature of about 90 to 105° C. during dropping. 910 g of allyl bromide (7.5 mol) was dropped for 6 hours and the liquid temperature was 86° C. after the completion of the dropping. After the completion of the dropping, it was further refluxed under heating for 4 hours and then gradually allowed to cool and a reaction mixture was recovered. It was separated into an organic layer, a small amount of an aqueous layer and a large amount of crystalline solids. Among them, the organic layer (468 g) was recovered, the crystalline solid and the aqueous layer were washed with diethyl ether and the washing liquid was joined with the organic layer. The mixture was concentrated by an evaporator at 40° C. into 434 g. The result of analysis for the obtained oil by liquid chromatography (analysis condition: column ODS-120-5-AP (trade name of products manufactured by Daiso K. K.), column temperature at 25° C., eluent: methanol: water-4:1, flow rate 1 ml/min) was as shown in Table 1 and a mixture of D-sorbitol allyl ether compound was obtained. An average allylation amount per one molecule (that is, average number of allyl groups) was about 3.0 by measurement according to ¹HNMR.

TABLE 1

| | Y (Number of | Ratio of area |
|---|---|---|
| | allyl groups | (%) by liquid |
| Compound | per molecule) | chromatography |
| D-solbitol monoallyl ether | 1 | 2.15 |
| D-solbitol diallyl ether | 2 | 17.14 |
| D-solbitol triallyl ether | 3 | 43.16 |
| D-solbitol tetraallyl ether | 4 | 22.51 |
| D-solbitol pentaallyl ether | 5 | 13.40 |
| D-solbitol hexaallyl ether | 6 | 1.01 |

The solubility of the mixture to an aqueous solution of acrylic acid salt was measured by the following method. 180 g of acrylic acid, 75 g of sodium hydroxide and 42 g of distilled water were mixed to prepare a standard aqueous solution of an acrylic acid salt at a monomer concentration of 32.4% by weight and a neutralization rate of 75 mol%. 10 g of the mixture obtained by the above described experiment was added to 100 g of the standard aqueous solution of acrylic acid salt, shaken vigorously and then stood still, and an aqueous solution was recovered from a resultant, solution in which two layers were separated. When it was analyzed by liquid chromatography (analysis condition: column ODS-12-5-AP (trade name of products manufactured by Diaso K. K.) column temperature at 25° C. eluate: methanol water=4:1, flow rate: 1 ml/min), the solubility was measured as 1.34 w/v%.

### Example 2

To a 2 liter four necked flask to which a stirrer, a dropping funnel, a reflux condenser, a thermometer and a mechanical stirrer were set, 272 g (2.0 mol) of pentaerythritol, 337 g (6.0 mol) of potassium hydroxide and 150 mL of water were charged and stirred under heating by a mantle heater to form a solution at 120° C. When dropping of allyl bromide thereto was started reflux was initiated and the liquid temperature was lowered to about 95° C. Subsequently, moderate refraction continued at a liquid temperature of about 90 to 105° C. during dropping. 726 g of allyl bromide (6.0 mol) was dropped for 8 hours and the liquid temperature was 93° C. after the completion of the dropping. After the completion of the dropping it was further refluxed under heating for 4 hours and then gradually allowed to cool and a reaction mixture was recovered. It was separated into an organic layer, a small amount of an aqueous layer and a large amount of crystalline solids. Among them, the organic layer was recovered. The mixture was concentrated by an evaporator at 40° C. into 458 g. The result of analysis (area ratio) for the obtained oil by gas chromatography (analysts condition: column BP20-0.25 (trade name of products manufactured by SGE Co.) 30 m; column temperature at 100 to 200° C., temperature elevation rate of 10° C./min)) was as shown in table 2 and a pentaerythritol allyl ether compound was obtained. The average allylation amount per one molecule was about 3.0 by measurement according to ¹HNMR.

TABLE 2

| | Y (Number of | Ratio of area |
|---|---|---|
| | allyl groups | (%) by gas |
| Compound | per molecule) | chromatography |
| pentaerythritol diallyl ether | 2 | 11.4 |
| pentaerythritol triallyl ether | 3 | 80.7 |
| pentaerythritol tetraallyl | 4 | 7.4 |
| ether | | |

For determining the solubility of the mixture to an aqueous solution of acrylic acid Salt, 10 g of the mixture obtained by the above described experiment was added to 100 g of the standard aqueous solution of the acrylic acid salt, shaken vigorously and then stood still, and an aqueous solution was recovered from the resultant solution in which two layers were separated. When it was analyzed a gas chromatography (analysis condition: column BP20-0.25 (trade name of products, manufactured by SGE Co.) 30 m; column temperature at 100 to 200° C., temperature elevation rate: 10° C./min)), the solubility was measured as 0.40 w/v%.

### Example 3

To a 2 liter four necked flask to which a stirrer, a dropping funnel, a reflux condenser, a thermometer and a mechanical stirrer were set, 522 g (3.0 mol) of α-D-glucose, 505 g (9.0 mol) of potassium hydroxide and 200 mL of water were charged and stirred under heating by a mantle heater to form a solution at 120° C.

When dropping of allyl bromide therto was started, reflux was initiated and the liquid temperature was lowered to about 950° C. Subsequently, moderate refraction continued at a liquid temperature of about 95 to 105° C. during dropping. 1090 g of allyl bromide (9.0 mol) was dropped for 8 hours and the liquid temperature was 93° C. after the completion of the dropping. After the completion of the dropping, it was further refluxed under heating for 4 hours and then gradually allowed to cool and a reaction mixture was recovered. It was separated into an organic layer, a small amount of an aqueous layer and a large amount of crystalline solids. Among them, the organic layer was recovered. The mixture was concentrated by an evaporator at 40° C. into 610 g. The result of analysis for the obtained oil by liquid chromatography (analysis condition: column ODS-120-5-AP, eluate: methanol: water=4:1, flow rate 1 ml/min) was as shown in Table 3. α-D-glucose allyl ether mixture was obtained The average allylation amount per one molecule was about 2.9 by measurement according to 1H NMR.

TABLE 3

| | Y (Number of | Ratio of area |
|---|---|---|
| | allyl groups | (%) by liquid |
| Compound | per molecule) | chromatography |
| α-D-glucose monoallyl ether | 1 | 2.68 |
| α-D-glucose diallyl ether | 2 | 26.40 |
| α-D-glucose triallyl ether | 3 | 40.22 |
| α-D-glucose tetra allyl ether | 4 | 29.75 |
| α-D-glucose pentaallyl ether | 5 | 0.95 |

For determining the solubility of the mixture to an aqueous solution of acrylic acid salt 10 g of the mixture obtained by the above described experiment was added to 100 g of the standard aqueous solution of the acrylic acid salt, shaken vigorously and then stood still, and an aqueous solution was recovered from the resultant solution in which two layers we're separated. When it was analyzed an liquid chromatography (analysis conditions: column ODS-12D-5-AP (nude name of product, manufactured by Daiso K. K.), column temperature at 25° C., eluate: methanol: water=4:1, flow rate 1 ml/min), the solubility was measured as 1.10 w/v%.

### Comparative Example 1

10 g of trimethylolpropane triacrylate was mixed to 100 g of the standard aqueous solution of the acrylic acid salt, saken vigorously and then stood still. When an aqueous layer of the solution in which two layers were separated was covered and analyzed an gas chromatography (analysis condition: column EP20-0.25 (trade name of product, manufactured by SGE Co.) 30 m; column temper=e at 100 to 200° C., temperature elevation rate of 10° C./min>>, solubility was measured as 0.20 w/v%. Solubility to the standard aqueous solution of the acrylic acid salt in the examples and the comparative example were collectively shown in Table 4.

TABLE 4

| | Example 1 | | Example 3 | Comparative |
|---|---|---|---|---|
| | Mixture of | Example 2 | Mixture of | Example 1 |
| | D-sorbitol | Mixture of | α-D-glucose | Trimethylol |
| | allyl | pentaerythritol | allyl | propane |
| Compound | ethers | allyl ethers | ethers | triacrylate |
| Average degree | 3.0 | 3.0 | 2.9 | — |
| of allyllation | | | | |
| Solubility | 1.34 | 0.40 | 1.10 | 0.20 |
| (w/w %) in | | | | |
| standard | | | | |
| aqueous- | | | | |
| solution of | | | | |
| acrylate salt | | | | |

All of the comounds in Examples 1 to 3 were superior in view of the solubility to the Standard aqueous solution of the acrylic acid salt compared with the comound of Comparative Example 1.

Preferred are Allylethers with a solubility of more than 1 (w/w%) in standard aqueous solution of acrylate salt for the production of water absorbing polymer.

Polyallylether show a better resistance in hydrolysis than the respective acrylates. This is especially relevant in the beginning of the drying process of water absorbing polymers where hydrolysis of the crosslinker could result in higher extractables and CRC. CRC and extractables strongly correlate to each other for given recipe of base polymer wherein the amount of crosslinker is varied. Base polymer is the water absorbing polymer after internal crosslinking before surface crosslinking. For PEGDA-400, an acrylate crosslinker, a CRC below 30 g/g can be obtained with 1.5 wt % crosslinker based on acrylic acid, a CRC of 25 g/g is obtained by using more than 2.5 wt % of PEGDA. These CRC values can be obtained with sorbitol allylethers of example 1 using 0.60 wt % (CRC 25 g/g) or 0.45 wt % (CRC 27 g/g) (of examples 12 and 13).

The use of sorbitol allylether of example 1 result in gels which are less tough and easier to tear compared with gels resulting from Polyethylenglycoldiallylether. Gels resulting from sorbitol triallylether used as crosslinker are easy to process, e.g. with regard of drying and milling.

After surface crosslinking the resulting gels show high SFC values (of example 10 and 11).

The sorbitol allylether as internal crosslinker can be used to produce base polymers which show after surface crosslinking unique properties.

The resulting surface crosslinked water absorbing polymers preferrably show a PAI-value between 100 and 125 more preferred between 105 and 115. Those polymers show a CRC value below 35 preferrably below 30, more preferred below 25. The ratio between AUL 0.01 and AUL 0.9 represents the ability of the waterabsorbing polymers to keep the liquid under different pressures. Waterabsorbing polymers with a ratio AUL 0.01/AUL 0.90 lower than 2.2, preferrably lower than 2.0, more preferrably lower than 1.8 can be obtained by the invention and are preferred polymers for hygienic applications like diapers which are exposed to a variance in external pressures. More preferred are water absorbing polymers which show simultaneously two or more of the given preferred parameters PAI, CRC, AUL-ratio. Water absorbing polymers are preferrably produced wherein the polymerization take place in kneaders.

(2) Preparation of Water Absorbing Polymer

### Example 4

To a one liter separable flask to which a nitrogen introduction tube (for use in liquid and for use in gas phase), a thermometer, a dropping funnel and a mechanical stirrer were set, 180 g (2.5 mol) of acrylic arid, 75 g (1.875 mol) of NaOH, 424 ml of water and 1.44 g (4.78 mmol) of the D-sorbitol allyl ether mixture obtained in Example 1 were charged and a vessel was ice cooled to an internal temperature of 5° C. At this point, the mixture was a colorless transparent liquid at pH of 5 to 6. After transferring them, together with the separable flask to a heat insulated vessel,150 mg (0.56 mmol) of 2,2′-azobis(2-amidinopropane) dihydrochloride dissolved in 1 ml of water and 100 mg (0.91 mmol) of 31% aqueous hydrogen peroxide dissolved in 1 ml of water were added successively within one min. The turbidity of the liquid mixture increased soon after the addition and the viscosity increased with generation of heat and the stirring was stopped. When it was left as it was, it reached a highest temperature (82° C.) 19 min after. It was then gradually allowed to cool to room temperature and the resultant colorless transparent gel was taken out of the vessel. A portion thereof of about 100 g was taken out and pulverized in a speed cutter. When it was pulverized to about 1 mm grain size, it was dried in an oven at 180° C. for 5 hours. The resultant solid was taken out of the vessel to obtain 28.0 g of a pale yellow solid. The solid was powdered by a. sample mill and then placed again in an oven (180° C.) and dried for 1.5 hours. After obtaining 25.9 g of a pale yellow powder, it was sieved to obtain 22.1 g of a powder having a grain size of 60 pm or more. The water absorbing performance of the thus prepared powdery polymer was measured. The water absorbing performance was 46 g/g.

### Example 5

A powdery polymer was prepared by the same method as in Example 4 except for replacing 1.44 g (4.78 mmol) of the D-sorbitol allyl ether mixture with 1.22 g (4.78 mmol) of the pentaerythritol allyl ether mixture obtained in Example 2. The water absorbing performance was 47 g/g.

### Example 6

A powdery polymer was prepared by the same method as in Example 4 except for replacing 1.44 g (4.78 mmol) of the D-sorbitol allyl ether mixture with 1.41 g (4.78 mmol) of the a-D-glucose allyl ether mixture obtained in Example 3. The water absorbing performance was 44 g/g.

### Comparative Example 2

A powdery polymer was prepared by the same method as in Example 4 except for replacing 1.44 g (4.78 mmol) of the D-sorbitol allyl ether mixture with 1.41 g (4.78 mmol) of trimethyl propane triacrylate. The water absorbing performance was 36 g/g.

### Example 7

To a one liter separable flask to which a nitrogen introduction tube (for use in liquid and for use in gas phase), a thermometer, a dropping funnel and a mechanical stirrer were set, 180 g (2.5 mol) of acrylic acid, 487 ml of water and 1.44 g (4.78 mmol) of the D-sorbitol allyl ether mixture obtained in Example 1 were charged and a vessel was ice cooled to an internal temperature of 5° C. At this point, the mixture was a colorless transparent liquid After transferring them together with the separable flask to a heat insulated vessel, 150 mg (0.56 mmol) of 2,2′-azobis(2-amidinopropane) dihydrochloride dissolved in 1 ml of water, 20 mg (0.113 mmol) of L-ascorbic acid dissolved in 1 ml of water and 100 mg (0.91 mmol) of 31% aqueous hydrogen peroxide dissolved in 1 ml of water were added successively within one min. The turbidity of the liquid mixture increased soon after the addition and the viscosity increased with generation of heat and the stirring was stopped. When it was left as it was, it reached a highest temperature (83° C.) 20 min after. It was then gradually allowed to cool to room temperature and the resultant colorless transparent gel was taken out of the vessel. A portion thereof of about 100 g was taken out and pulverized in a speed cutter. When the gram size was reduced to about 1 mm or less, 23.5 g of an aqueous solution of 48% sodium hydroxide was added and pulverization was continued for further 30 min. The resultant pulverized gel mixture was dried in an oven at 180° C. for 5 hours to obtain 28.56 g of a pale yellow solid The solid was powdered by a Sample mill and then placed again in an oven (180° C.) and dried for 1.5 hours. After obtaining 26.2 g of a pale yellow powder, it was sieved to obtain 23.2 g of a powder having a grain size of 60 μm or more. When the water absorbing performance of the thus prepared powdery polymer was measured, the water absorbing performance was 46 g/g.

### Example 8

A powdery polymer was prepared by the same method as in Example 7. except for replacing 1.44 g (4.78 mmol) of the D-sorbitol allyl ether mixture with 1.22 g (4.78 mmol) of the pentaerythritol allyl ether mixture obtained in Example 2. The water absorbing performance was 49 g/g.

### Example 9

A powdery polymer was prepared by the same method as in Example 7 except for replacing 1.44 g (4.78 mmol) of the D-sorbitol allyl ether mixture with 1.41 g (4.78 mmol) of the a-D-glucose allyl ether mixture obtained in Example 3. The water absorbing performance was 43 g/g.

In the following examples Sorbitoltriallylether as described in example 1 was used.

### Example 10

A laboratory kneader (Type LUK 8,0 KZTV with 2 Sigmashovel of WERNER & PFLEIDERER) was used. 6 kg of 35.5 wt % Acrylic Acid in Water was neutralized to a degree of 72 mol-% using Sodium hydroxide. 0.69 wt % of Sorbitoltriallylether were added. The polymerization was started using 0.28 wt % Sodiumpersulfate and 0.0056 wt % Ascorbic acid (calculated as wt % related to acrylic acid). The reaction was started and the mantle of the kneader was heated to minimize cooling through the mantle (nearly adiabatic reaction path). The temperature was kept for approximately one hour after the reaction has come to an end. A crumbly gel was obtained which was dried for additional 3 hours using circulating air at 160° C. The material was milled and sieved to receive a particle size distribution between 100 and 850 μm of the hydrogel powder.

The hydrogel powder was homogeneously sprayed with 0.10 wt % 2-Oxazolidinone, 3.43 wt % water and 1.47 wt % Methanol. The wet powder was stirred and tempered for 60 minutes at 175° C. Agglomerates larger than 850 μm were removed by sieving. Properties of the material are shown in table 6.

### Example 11

As example 10 but 0.34% of Sorbitoltriallylether were used.

### Example 12 and 13

A 40 wt % solution of partly neutralized Acrylic Acid (72 mol-% using NaOH) was used in a contineous reactor ORP 250 of LIST. 600 kg solution per hour were fed. Start temperature was 18° C., starter are Sodiumpersulfate, Ascorbic acid and H₂O₂.

In example 12, 0.60 wt % Sorbitoltriallylether, in example 13 0.45 wt % Sorbitoltriallylether were used. Wt % refer to weight percent relative to acrylic acid Monomer.

The crumbly get was dried by circulating air at 160° C. for 3 hours, milled and sieved (100 μm-850 μm). The properties of the base polymer are shown in table 5.

### Example 14-17

The material of example 14 to 17 were analogeous to example 12 and 13 produced but 0.60 wt %, 0.45 wt %, 0.3 wt % and 0.15 wt % of Sorbitoltriallylether were used. The base polymers were homogenously sprayed with a solution of 0.10 wt % 2-Oxazolidinone, 3.43 wt % water and 1.47 wt % Isopropanol (wt % in relation to polymer). The wet power was stirred and tempered for 60 minutes at 175° C. Agglomerates were removed by wieving at 850 μm. Properties are shown in table 6.

### Example 18-21

The production of the base polymers was performed analogeous to example 14-17 using 0.60 wt %, 0.45 wt %, 0.30 wt % and 0.15 wt % sorbitoltriallylether. The base polymers were surface crosslinked by spraying a solution of 0.06 wt % Ethyleneglycoldiglycidylether (Decanol EX-810, Nagase), 3.3 wt % water and 1.7 wt % 1.2-propanediol (wt % relating to the weight of the base polymer). The wet powder was stirred and tempered at 150° C. for 60 minutes. Agglomerates were removed by sieving (<850 μm). The properties are shown in table 6.

TABLE 5
Base polymers

| Example | CRC | AUL 0.01 | AUL 0.29 | AUL 0.57 | AUL 0.90 | PAI |
|---|---|---|---|---|---|---|
| 12 | 25 | 36 | 25 | 19 | 9 | 89 |
| 13 | 27 | 38 | 25 | 14 | 9 | 86 |

TABLE 6
Surface crosslinked polymers

| | Sorbitoltriallylether | AUL | AUL | AUL | AUL | | | | AUL |
|---|---|---|---|---|---|---|---|---|---|
| Example | [wt. % boaa] | 0.01 | 0.29 | 0.57 | 0.90 | PAI | CRC | SFC | 0.01/0.9 |
| 10 | 0.69 | | | | | | 22 | 145 | |
| 11 | 0.34 | | | | | | 23 | 120 | |
| 14 | 0.60 | 35 | 25 | 23 | 22 | 105 | 22 | | 1.59 |
| 15 | 0.45 | 36 | 26 | 24 | 22 | 108 | 23 | | 1.63 |
| 16 | 0.30 | 38 | 28 | 25 | 23 | 113 | 24 | | 1.65 |

TABLE 6
Surface crosslinked polymers

| | Sorbitoltriallylether | AUL | AUL | AUL | AUL | | | | AUL |
|---|---|---|---|---|---|---|---|---|---|
| Example | [wt. % boaa] | 0.01 | 0.29 | 0.57 | 0.90 | PAI | CRC | SFC | 0.01/0.9 |
| 17 | 0.15 | 42 | 30 | 27 | 23 | 122 | 28 | | 1.82 |
| 18 | 0.60 | 37 | 26 | 23 | 21 | 108 | 23 | | 1.76 |
| 19 | 0.45 | 38 | 27 | 25 | 22 | 112 | 25 | | 1.72 |
| 20 | 0.30 | 40 | 29 | 26 | 23 | 118 | 27 | | 1.74 |
| 21 | 0.15 | 44 | 32 | 26 | 21 | 123 | 31 | | 2.09 |

Other surface crosslinking agents which can be used are well known in the art. Examples for surface crosslinker are Oxazolidon, Primid XL 552, Decanol EX-810, N-hydroxyethyl-2.3-morpholindion). Additional coating with Al-sulfate or Hydroxy apatite can further the properties of the water absorbing polymer.

What is claimed is:

1. A highly water absorbing polymer obtainable by polymerization of a polymerizable compound having a carbon-carbon double bond or a salt thereof, and a crosslinking agent comprising a hydroxy polyallyl ether having one or more hydroxy groups and two or more allyl groups.

2. The polymer of claim 1 wherein the crosslinking is performed in an aqueous medium.

3. The polymer of claim 1 wherein the polymerizable compound further has a carboxyl group.

4. The polymer of claim 1 wherein the hydroxy polyallyl ether is obtained by allyl etherifying hydroxy groups of a polyol compound represented by the formula R(OH)ₙ, said hydroxy polyallyl ether represented by the formula R(OH)ₓ(OA)_{y}, wherein R represents a hydrocarbon group of 4 to 12 carbon atoms having a linear, branched, or cyclic structure which optionally contains an ether linkage oxygen atom, n is an integer of 3 to 10, x is an integer of 2 or more, x+y is 10 or less, and A represents an allyl group.

5. The polymer of claim 4 wherein the polyol compound is a linear compound of 4 to 10 carbon atoms.

6. The polymer of claim 5 wherein the polyol compound is selected from the group consisting of erythritol, xylitol, sorbitol, and mixtures thereof.

7. The polymer of claim 5 wherein the polyol compound comprises sorbitol triallyl ether.

8. The polymer of claim 4 wherein the polyol compound is a branched compound of 4 to 12 carbon atoms.

9. The polymer of claim 7 wherein the polyol compound comprises dipentaerythritol.

10. The polymer of claim 4 wherein the polyol compound is a cyclic compound of 4 to 12 carbon atoms.

11. The polymer of claim 10 wherein the polyol compound is a compound selected from the group consisting of glucose, fructose, maltose, sucrose, lactose, and mixtures thereof.

12. The polymer of claim 1 wherein the polymerization is performed in a kneader.

13. The polymer of claim 1 having a PAI value between 100 and 125.

14. The polymer of claim 1 having a PAI value between 105 and 115.

15. The polymer of claim 1 having a CRC below 35 g/g.

16. The polymer of claim 1 having a CRC below 30 g/g.

17. The polymer of claim 1 having a ratio AUL 0.01/AUL 0.90 lower than 2.2

18. The polymer of claim 1 having a ratio AUL 0.01/AUL 0.90 lower than 2.0.

19. The polymer of claim 1 wherein after the polymerization the polymer is surface crosslinked.

20. A surface crosslinked highly water absorbing polymer having a ratio of AUL 0.01/AUL 0.90 lower than 1.8.
